(19) United States
(12) Patent Application Publication
(10) Pub. No.: US 2015/0076951 A1
(43) Pub. Date: Mar. 19, 2015

(54) ELECTRIC MACHINE CONSTRUCTION

(71) Applicant: Hamilton Sundstrand Corporation, Windsor Locks, CT (US)

(72) Inventors: Matthew E. Lynch, Canton, CT (US); Tahany Ibrahim El-Wardany, Bloomfield, CT (US); William A. Veronesi, Hartford, CT (US); Jagadeesh Tangudu, South Windsor, CT (US); Andrzej Ernest Kuczek, Bristol, CT (US); Vijay Jagdale, Manchester, CT (US)

(73) Assignee: Hamilton Sundstrand Corporation, Windsor Locks, CT (US)

(21) Appl. No.: 14/190,516

(22) Filed: Feb. 26, 2014

Related U.S. Application Data
(60) Provisional application No. 61/878,457, filed on Sep. 16, 2013.

(51) Int. Cl. H02K 3/12; H02K 3/50

(52) U.S. Cl. CPC H02K 3/12; H02K 3/50
USPC 310/195

(57) ABSTRACT

An electric machine includes a laminated stack. The laminated stack includes first and second additively manufactured conductive phase coils. Each of the first and second additively manufactured phase coils includes of a plurality of conductive strands. An additively manufactured end winding conductively couples the first and second phase coils. The end winding has a non-circular cross-sectional geometry.

### CROSS-REFERENCE TO RELATED APPLICATION

This application claims priority to U.S. Provisional Application No. 61/878,457, filed on Sep. 16, 2013, and entitled “Electric Machine Construction,” the disclosure of which is incorporated by reference in its entirety.

### BACKGROUND

The present invention relates to the production of electric machines such as motors or generators.

A typical motor operates by applying an alternating current to the stator windings of the motor. The alternating current generates a rotating magnetic field that interacts with the rotor to provide mechanical force to the rotor.

Various winding configurations may be employed by the stator depending on the application. Conductive wires that connect the strands of one stator slot to another are referred to as end windings. Depending on configuration the end windings of different coils may overlap one another.

In general, higher conductor power density, lower volume, and higher efficiency are all desirable features for electric machines. For example, a stator slot includes insulated conductive material (e.g. copper). The term “fill factor” defines the portion of the cross-section of a slot that is comprised of the conductive material. Previously known copper bundles used in the end windings of electric machines typically achieve fill factors of between 35% and 45%.

The end windings are a significant portion of the overall winding length and therefore are responsible for much of the resistive losses in the motor. Known end windings bend wires exiting one portion of the electric machine and enter into another portion of the electric machine in an arc to connect coils. Since the wire arcs extend from the motor body, the path lengths contribute to the total resistance of the winding resulting in increased conductor losses.

### SUMMARY

An electric machine includes a laminated stack. First and second additively manufactured conductive phase coils are positioned in the laminated stack. These coils are comprised of a plurality of conductive strands. An additively manufactured end winding conductively couples the first and second phase coils. The end winding has a non-circular cross-sectional geometry.

### BRIEF DESCRIPTION OF THE DRAWINGS

FIG. 1 is a perspective view of a rapid prototyping system, as well a partially constructed stator component for use in an electric machine.

FIG. 2 is a perspective cutaway view of a stator of an electric machine.

FIG. 3 is an enlarged view of region 3 of the stator shown in FIG. 2.

FIG. 4A is a perspective view of a linear leg end winding.

FIG. 4B is a perspective view of a plurality of linear leg end windings.

FIG. 4C is a cross-sectional view of the plurality of linear leg end windings.

FIG. 5A is a perspective view of a non-linear end winding.

FIG. 5B is a perspective view of a plurality of non-linear end windings.

FIG. 5C is a cross-sectional view of the plurality of non-linear end windings.

FIG. 6A is a perspective view of a trapezoidal end winding.

FIG. 6B is a perspective view of a plurality of trapezoidal end windings.

FIG. 6C is a cross-sectional view of the plurality of trapezoidal end windings.

FIG. 7 is a perspective view of a stair-stepped embodiment of end windings.

### DETAILED DESCRIPTION

Various benefits of additive manufacturing of electric machines are described in U.S. patent application Ser. No. 13/566,615 (filed 3 Aug., 2012). The present disclosure describes unique end winding structures that are constructed by additive manufacturing. The embodiments described with respect to this application do not include slot openings, as discussed herein, but the invention could be used with respect to embodiments having slot openings as well.

The present invention discloses end winding geometries and configurations that decrease the size of the end windings and therefore improve performance by way of reducing total machine weight and volume. Additive manufacturing techniques are utilized to manufacture the desired geometries and configurations. For example, the present invention utilizes various corners in individual end windings, and also allows end windings to jog so as to bypass other end windings or end winding bundles to provide more compact end windings. In addition, optimization of these end windings effectively utilizes the additive manufacturing process to reduce weight and aid in producing a motor/generator. In some embodiments, such optimization may obviate the need to include rare earth magnets, thus decreasing cost other materials requirements. Further, the various geometries and configurations of the end windings facilitate higher concentrations of conducting material both within the slots and in the end windings, with fill factors of 50% or more.

Conventional windings consist of bundles of wires spanning over several slots, overlapping the end turns of the other phases contributing to additional copper losses. The present invention leverages an additive manufacturing technique's capability to produce significantly shorter end windings compared to conventional windings. Additive manufacturing allows end turn windings that do not extend as far from the laminates and therefore can be significantly shorter.

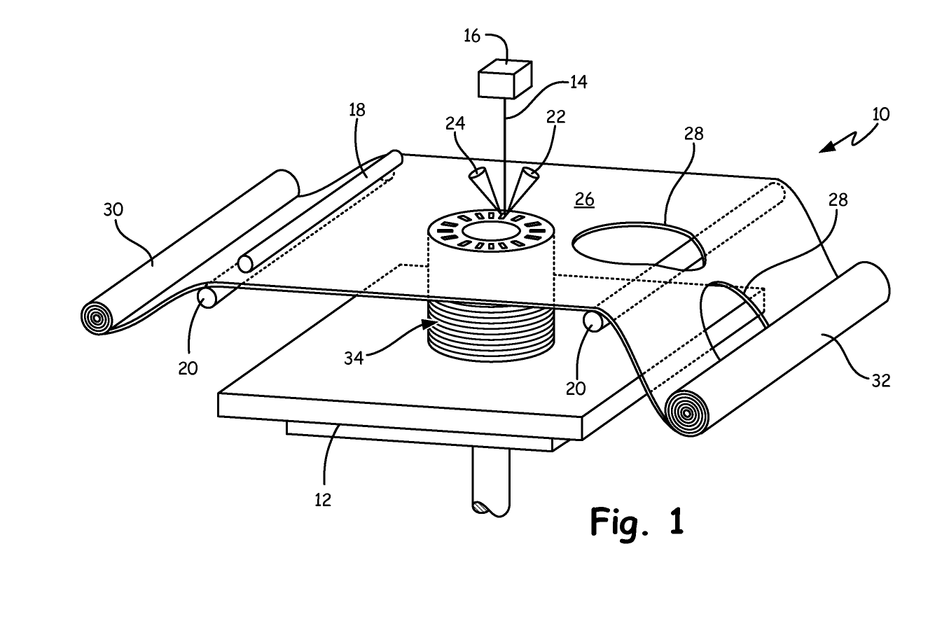

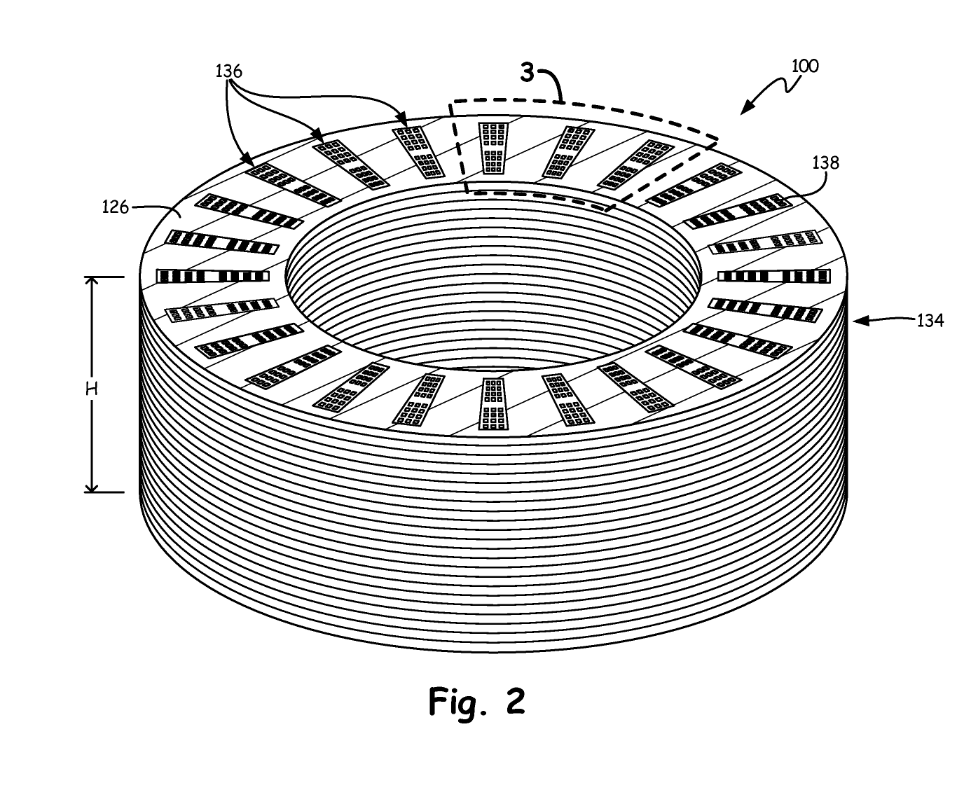

FIG. 1 is a perspective view of rapid manufacturing system 10 in the process of manufacturing a stator of an electric machine incorporating unique geometries and configurations of end windings. FIG. 1 shows rapid manufacturing system 10 partway through building a stator component (e.g., component 100 of FIG. 2) using laser additive manufacturing (LAM). Rapid manufacturing system 10 of FIG. 1 includes movable support 12, radiation beam 14, movable optical head 16, heated roller 18, guides 20, first LAM apparatus 22, and second LAM apparatus 24. In the embodiment shown in FIG. 1, first LAM apparatus 22 and second LAM apparatus 24 are both Laser Engineered Net Shaping (LENS) type rapid manufacturing/additive manufacturing devices.

Sheet material 26 is supplied to rapid manufacturing system 10 from supply roll 30 and collected by take-up roll 32 after being moved past laminated stack 34. Each layer of laminated stack 34 is made up of a combination of sheet material 26, insulating material deposited by first LAM apparatus 22, and conductive material deposited by second LAM apparatus 24. In this way, a 3-dimensional stator component is created as a stack of thin, nearly 2-dimensional layers. A benefit of this approach is that the conductive windings, normally wound around a stator core after manufacture of the core, are manufactured along with the stator core.

As sheet material 26 is advanced from supply roll 30 to above movable support 12 to take-up roll 32, movable optical head 16 directs laser radiation toward the hole outlines 28 in sheet material 26. Within these lased outlines, movable optical head 16 may cut additional features, such as an outer periphery of a layer as well as apertures for desired features within the layer. For example, features may include cooling channels, or apertures for conductive or insulating materials to be positioned within the layers. Some portion of the material within each outline is removed and either discarded or recycled. First LAM device 22 and second LAM device 24 are used to deposit sinterable or meltable materials in desired locations. For example, first LAM device 22 may be used to deposit a sinterable insulating material within apertures cut by laser radiation emanating from movable optical head 16. The insulating material deposited by first LAM device 22 need not fill the entirety of apertures cut by laser radiation emanating from movable optical head 16. Rather, it is sometimes desirable to additively manufacture additional features of a different material. For example, second LAM device 24 may deposit conductive material within the apertures cut by laser radiation emanating from movable optical head 16. The combination of conductive and insulative materials allows for bundles of coils to be manufactured integrally with the stator component as desired.

Each time a layer of sheet material 26 is cut and additive manufacturing is complete, heated roller 18 laminates the layer to an underlying structure and movable support 12 moves away from sheet material 26 by roughly the thickness of one layer. The thickness of each layer is set by the thickness of sheet material 26. For example, sheet material 26 may be between 0.10 and 0.25 mm thick. The amount of movement of movable support 12 may be different from the thickness of sheet material 26, if lamination by heated roller 18 causes any change to the thickness of the layer. The layer becomes the topmost part of laminated stack 34, and also the physical support for the next layer that is constructed. After lamination and movement of movable support 12, supply roll 30 and take-up roll 32 rotate to advance a different portion of sheet material 26 over movable support 12 and laminated stack 34.

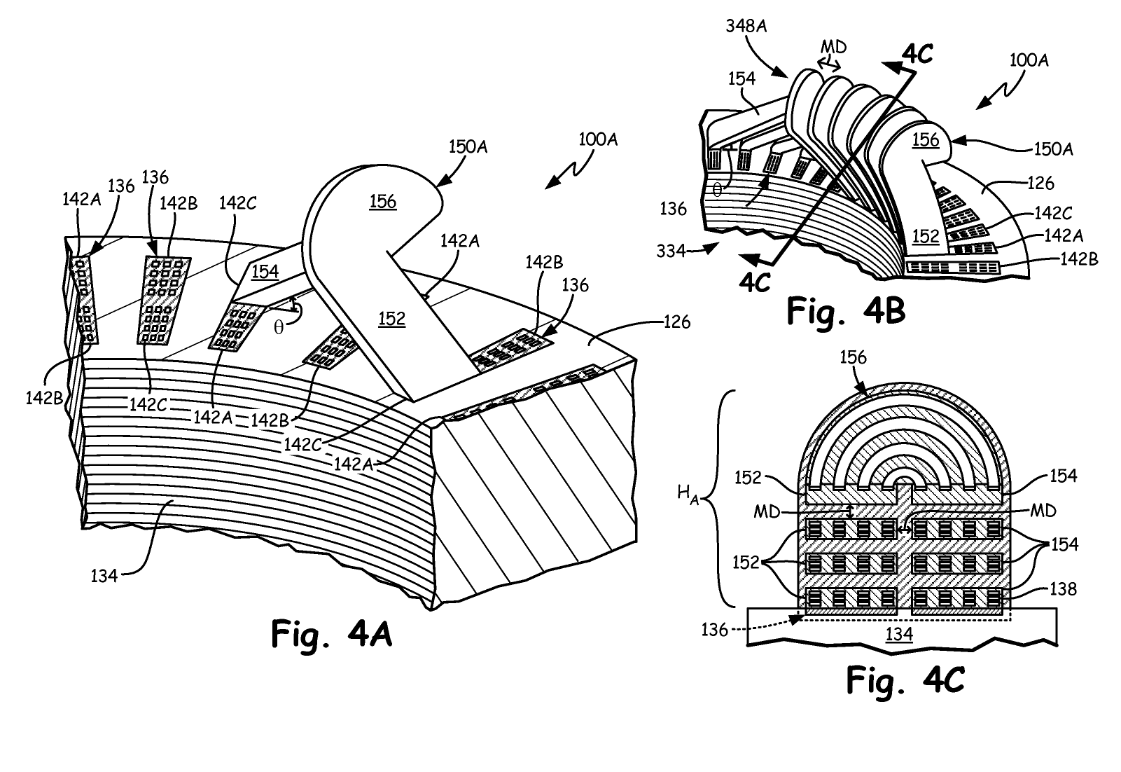

FIG. 2 is a perspective cutaway view of laminated stack 134 of a stator component 100. Component 100 is made in a layerwise fashion, and includes laminated stack 134 as well as an end winding portion (e.g., end windings 150A-150C of FIGS. 4A-6C). In the embodiment shown in FIG. 2, component 100 is a stator in which the conductive coils and surrounding insulator are formed using additive manufacturing techniques. Stator component 100 is formed by the stacking of a plurality of sheets of sheet material 126, many of which have apertures cut therein that are filled with additively manufactured features as described with respect to FIG. 1 to create slots 136. In alternative embodiments, component 100 can be a rotor component or any other component of an electric machine having additively manufactured windings.

In known electric machines, slots typically include a gap at the radially inner portion of a conductor stator, such that the coils may be wound through the air gap and into the body of the stator. Typically, one, two, or more phases of an electric machine are wrapped into each slot. In the present invention, a slot opening is not required and there are no empty spaces between the conductors as in current electric machines, because the additively manufactured insulative and conductive portions can be built into the stator body as it is constructed, as described with respect to FIG. 1. A slot opening is no longer required for inserting the winding into the slots because an additive manufacturing technique can be used to build the winding as the laminations are stacked. In alternative embodiments, a slot can still be included if the electromagnetic design so dictates. In the embodiment shown with respect to FIG. 2, slots 136 contain two phases of an inductive machine and could accommodate the layout of an integral-slot distributed winding (ISDW) pattern or a fractional slot concentrated winding (FSCW) pattern.

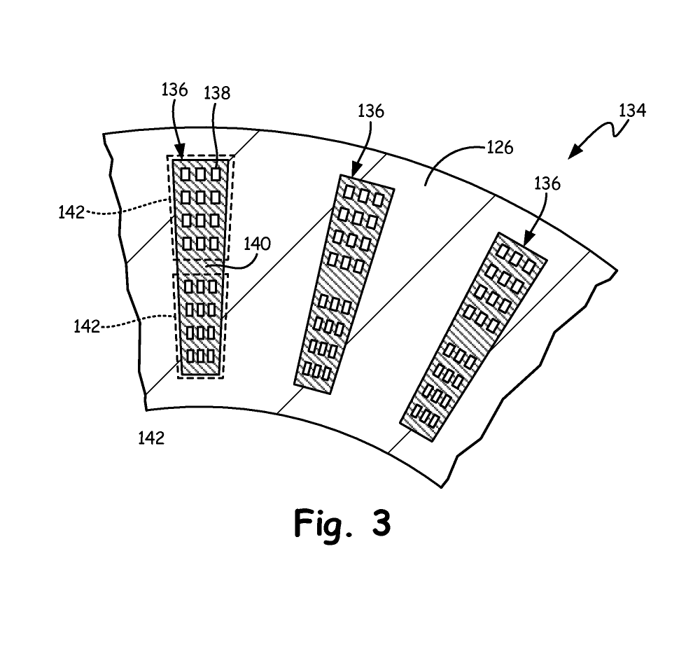

Slots 136 are arranged within apertures in sheet material 126 such that strands 138 (FIG. 3) are at least partially aligned with conductive additively manufactured features in at least one adjacent layer of laminated stack 134 of stator component 100. Insulating portions 140 (FIG. 3) of additively manufactured features are arranged to prevent electrical contact between conductive additively manufactured features and/or sheet material 126, either in the same layer of laminated stack 134 or in adjacent layers of stator component 100. In this way, the coils of an electrical phase of an inductive machine are built layer by layer within component 100 until it reaches a desired axial height H.

In one embodiment, the conductive additively manufacture portions may be made of a conductive metal, such as copper. The insulating layer can be polymeric, such as PolyEther Ether Ketone (PEEK), or ceramic, such as aluminum oxide or glass. In some embodiments, the sheet material may be a magnetic material such as silicon steel.

By choosing appropriate arrangements of additively manufactured conductive and insulative features within slots 136, conductive materials are positioned in the same or similar locations to the coils of traditional stator slots. As discussed in more detail in FIG. 3, the conductive and insulative features that form such coils terminate at slots 136, and may have their topology optimized to reduce interference and eddy currents as a result of current flowing through such coils. Additionally, end windings may be additively manufactured with unique geometries and paths to reduce end winding size and weight.

FIG. 3 is an enlarged view of region 3 of FIG. 2. FIG. 3 illustrates several additively manufactured features of stator component 100 of FIG. 2 at the junction between laminated stack 134 and adjacent end windings (not shown). In particular, FIG. 3 illustrates several slots 136 built into one sheet material 126 that forms laminated stack 134. Each of slots 136 includes a plurality of strands 138 separated from one another by insulator material 140. Strands 138 are made of conductive materials that are additively manufactured in veins through several adjacent sheet materials 126 that form laminated stack 134 (FIG. 2). Insulator material 140 is arranged to surround and insulate each of strands 138, which are conductive, from one another. Strands 138 are segregated into several phase coils 142, which are separated from other phase coils 142 by substantially more insulator material 140. The coils so built are arranged to form the coils of the electric machine.

Phase coils 142 are selectively electrically interconnected by additively manufacturing end windings. One type of winding pattern that may be constructed with the windings described herein is the fractional slot concentrated winding pattern (FSCW). In an FSCW end winding pattern, each stator slot houses two windings of different phases.

A benefit of FSCW winding machines is it provides a high winding factor for the space harmonic (synchronous harmonic) that is interacting with the rotor fundamental harmonic in producing airgap electromagnetic torque. Also, FSCW winding arrangements facilitate short end winding length, which reduces copper volume, shortens machine length, and lowers copper losses, resulting in higher machine efficiencies. In addition, FSCW end windings do not intersect with adjacent end windings, which simplifies the end winding configuration. However, FSCW winding arrangements introduce sub and super spatial harmonic frequencies around the synchronous harmonic component resulting in additional leakage flux and higher rotor core losses. Removing these losses from a rotating component is challenging. They can be minimized by adopting more complex winding patterns such as an ISDW winding pattern.

Another type of winding pattern that can include the windings disclosed herein is an integral-slot distributed winding (ISDW) pattern.

The flowpaths of an ISDW winding pattern must necessarily cross one another, thus the overlap between end windings results in end windings with relatively long paths between stator slots that results in a larger machine with greater losses than those of FSCW machines. ISDW winding machines also have relatively higher winding factor than FSCW machines. The slot harmonic frequencies of ISDW machines are typically higher and their harmonic magnitudes are significantly lower when compared to loss-producing harmonics magnitudes in FSCW designs. Thus, ISDW machines may have lower rotor side losses, but have traditionally been physically larger due to their more complicated end winding structures.

The following figures illustrate the end windings that may be used to connect the conductive coils additively built into stator component 100. In particular, FIGS. 4A-6C illustrate one family of end winding configurations in which the end windings are formed based on smooth, continuous, swept geometries.

FIG. 4A is a perspective view of a linear leg end winding 150A extending from laminated stack 134 at angle 8 from the final non-end winding layer 126 built during additive manufacturing. Linear leg end winding 150A includes first leg 152, second leg 154, and semicircular bridge 156. Linear leg end winding 150A is comprised of a bundle of conductive, additively manufactured regions configured to electrically connect to each of the strands 138 of a single phase coil 142C. In the embodiment shown in FIG. 4A, stator component 100A is a portion of a double layer three-phase electric machine. Thus, stator component 100A includes three phases: a first phase comprising coils 142A; a second phase comprising coils 142B; and a third phase comprising coils 142C. The coils that make up any given phase are in electrical communication with each other, while the three phases are electrically insulated from one another.

Linear leg end winding 150A connects phase coils 142C from one slot 136 to another. Strands 138 that form phase coil 142C are electrically connected to the conductive portions of linear leg end winding 150A at first leg 152. Strands 138 that form another phase coil 142C are electrically connected to linear leg end winding 150A at second leg 154. In this way, two of first phase coils 142C are interconnected.

As shown in FIG. 4A, first leg 152 and second leg 154 extend away from the surface of laminated stack 134 at angle 8, the magnitude of which affects the rise and run of linear leg end winding 150A. Each of the legs extends from a phase coil 142C to semicircular bridge 156, which is a semi-circular portion of conductive material arranged perpendicular to the final non-end winding layer 126. Linear leg end winding 150A has a rectangular or trapezoidal cross-section along its entire length. First linear leg 152 extends in a first direction away from the surface of laminated stack 134, and the cross-section of first leg 152 perpendicular to the first direction is rectangular or trapezoidal. Second leg 154 similarly has a rectangular or trapezoidal cross-section perpendicular to a second direction along which it extends from laminated stack 134. Semicircular bridge portion 156 has a rectangular cross-section as it loops to connect first linear leg 152 and second linear leg 154.

Linear leg end winding 150A is additively manufactured. In the additive manufacturing apparatus shown in FIG. 1, sheet material 26 supports and surrounds features that are additively manufactured therein. However, sheet material 26 need not surround linear leg end winding 150A. Instead, linear leg end winding 150A may be additively manufactured by laser powder deposition and/or direct metal laser sintering. In each of these additive manufacturing processes, one or more pulverant materials are sintered and/or melted in a layerwise pattern to generate a 3-dimensional, multilayer structure. Linear leg end winding 150A may be constructed using either of these techniques or their equivalents to form conductive strands surrounded by insulating material arranged within linear leg end winding 150A. The conducting and insulating portions are formed of separate pulverant materials, without necessarily requiring a surrounding sheet material.

FIG. 4B is a perspective view of a plurality of linear leg end windings 150A that illustrates the relative location and spacing of the linear leg end windings 150A. In the view shown in FIG. 4B, six linear end windings 150A are nested against one another. In alternative embodiments, end winding bundles may contain substantially more individual windings.

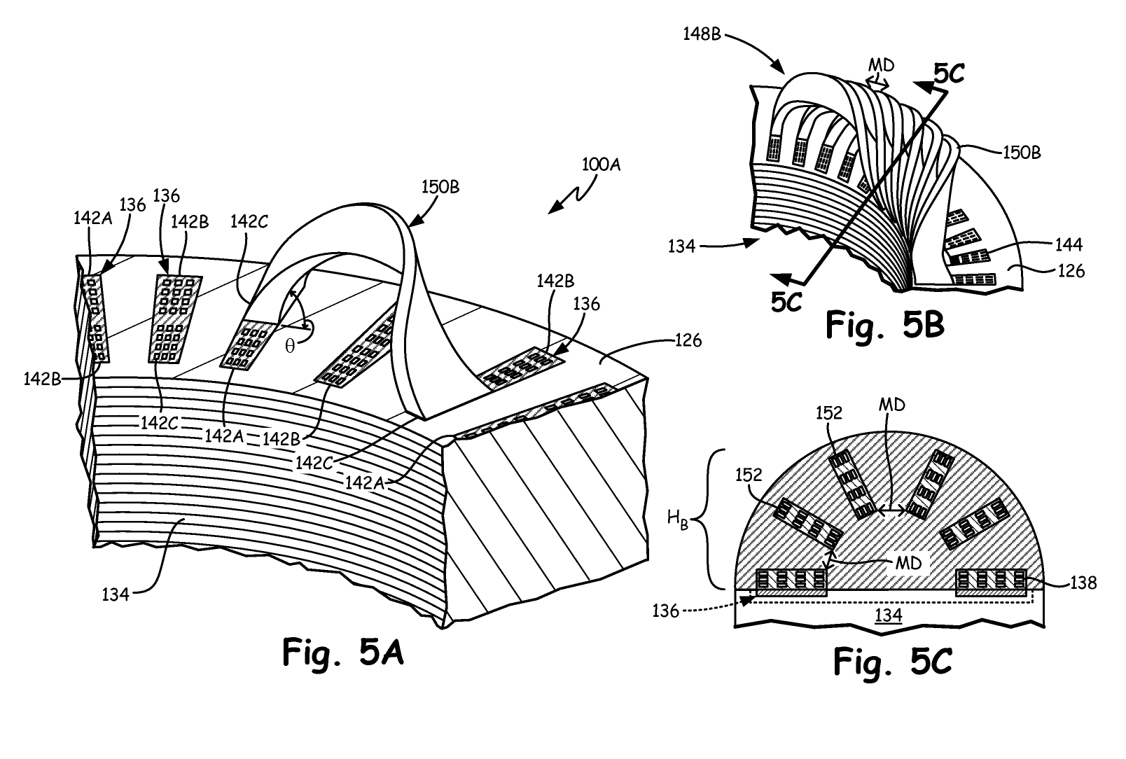

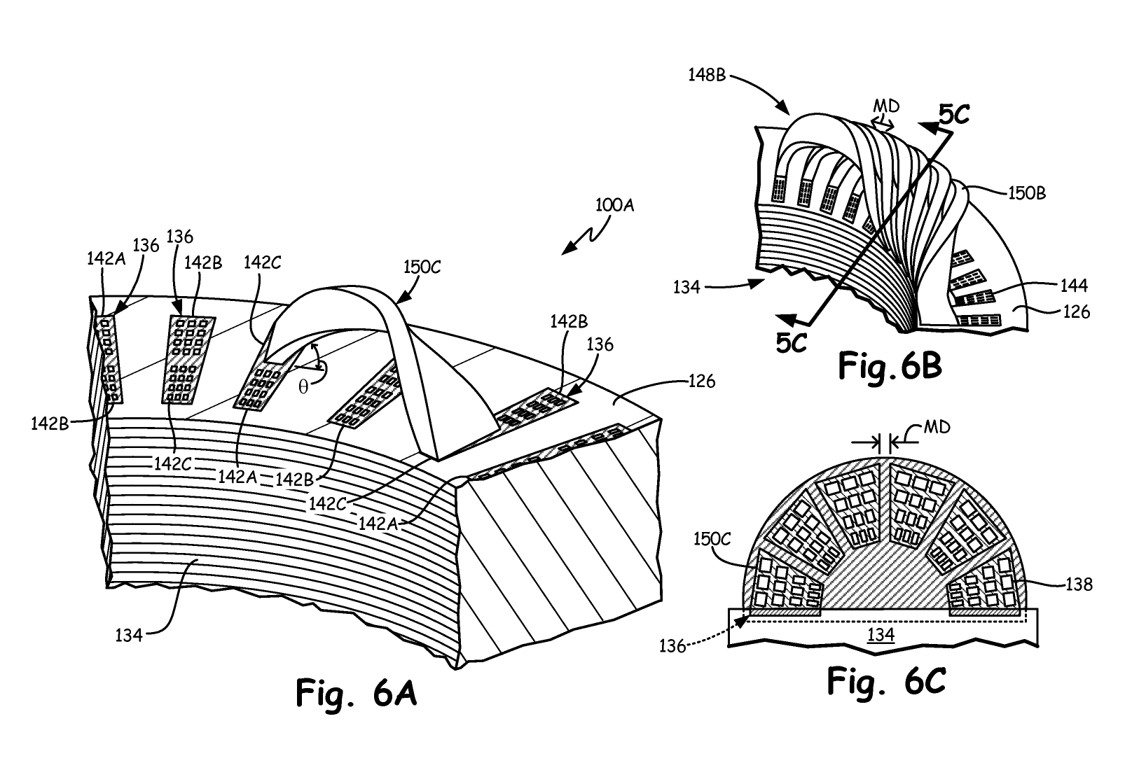

Each of the legs of end windings 150A extends from laminated stack 134 at an angle θ from the topmost sheet material 126. In the embodiment shown in FIG. 5A, θ is approximately 45°. In alternate embodiments, θ may be between 0° and 90°. Space between adjacent phases includes insulating material and/or empty space. The fill factor is the percentage of the end windings that is comprised of conductive material. In the embodiment shown in FIG. 6A, the fill factor is greater than 50%. There is a predetermined minimum distance MD between adjacent conductive end windings.

FIG. 4C is a cross-sectional view of stator component 100A and five of end windings 150A of FIG. 4B, viewed along line 4C-4C. As shown in FIG. 4C, each phase is separated from adjacent phases by at least minimum distance MD. Further, each end winding 150A includes several conductive strands 138 separated by insulating material 140. One of first legs 152 and one of second legs 154 are connected to laminated stack 134 at slot 136.

The cross-section of each of the linear leg portions of linear end windings 150A is rectangular or trapezoidal. The cross-sections over various linear end windings 150A of end winding bundle 348A are oriented in the same direction, although in other embodiments other non-circular shapes may be used.

The cross-section shown in FIG. 4C illustrates a compact end winding configuration that can be achieved by additively manufacturing end windings 150A. By additively manufacturing linear leg end windings 150A, high densities of conductive material can be packaged into a relatively short end winding. In this way, linear leg end winding height H_{A} is minimized. In the embodiment shown in FIG. 4A, the ratio of linear leg end winding height H_{A} to laminated stack height H (FIG. 2) can be 1:6 or higher. Even more preferably, the ratio of H_{A} to laminated stack height H can be 1:9 or higher, or even 1:12 or higher. Shorter end windings are beneficial for many reasons, such as reduced weight, reduced size, reduced materials requirements for construction of the machine, and reduced conductor path length (for decreased electrical losses).

FIG. 5A illustrates non-linear end winding 150B. In contrast with the linear embodiment, non-linear end winding 150B does not include linear legs 152 and 154. Rather, non-linear end winding 150B has a uniform transition of cross-section as it twists to connect one slot 136 to another.

Non-linear end winding 150B is a conductive end winding with a non-circular cross-section. The non-circular conductive winding facilitates high fill factors and simplified end winding bundle patterns. As previously described with respect to FIG. 4A, non-linear end winding 150B is additively manufactured of both conductive and insulative materials.

In the embodiment shown in FIG. 5A, non-linear end winding 150B has a rectangular or trapezoidal cross-section as it twists from one phase coil 142 to another. In this way, coils of stator component 100 can be electrically interconnected. In the embodiment shown in FIG. 5A, non-linear end winding 150B twists a total of 180° for a phase coil 142 along its path from one slot 136 to another corresponding slot.

FIG. 5B is a perspective view including a plurality of non-linear end windings 150B. Slots 136 each include two phase coils 142, comprised of a plurality of conductive strands 138. Each non-linear end winding 150B electrically connects one phase coil 142 to another phase coil 142 positioned in a different slot 136. The space between end windings 150B may be empty space, as depicted in the embodiment in FIG. 5B, or filled with insulative material.

FIG. 5C is a cross-sectional view of the plurality of non-linear end windings 150B, as viewed along line 5C-5C of FIG. 5B. As shown in FIG. 5C, non-linear end windings 150B each have a rectangular cross section as they loop from one slot 136 to a corresponding slot 136 of the same phase. Non-linear end windings 150B may transition to a shape having a trapezoidal cross-section in order to interface with the conductive portions of the coils at slots 136. A minimum distance, MD, is maintained between the groups of conductive strands 138 that connect phase coils 142. In some cases, for example at the regions of each non-linear end winding 150B furthest from laminated stack 134, non-linear end windings 150B may be positioned further from one another than minimum distance MD.

By additively manufacturing non-linear end windings 150B, high densities of conductive material can be packaged into a relatively short end winding. In the embodiment shown in FIGS. 5A-5C, the ratio of end winding height H_{B} to laminated stack height H (FIG. 2) can be 1:6 or higher. In some embodiments, the ratio of H_{B} to laminated stack height H may be even greater, such as 1:9 or higher, or even 1:12 or higher. Height H_{B} would be smaller than height H_{A} (FIG. 4C) for an otherwise identical motor design, due to the higher fill factors that can be achieved with non-linear end winding 150B as compared to linear leg end windings 150A (FIGS. 4A-4C).

FIG. 6A is a perspective view of stator component 100 illustrating trapezoidal end winding 150C. Trapezoidal end windings 150C are a type of non-linear end windings (e.g. non-linear end windings 150B of FIGS. 5A-5C). In contrast to non-linear end windings 150B of FIGS. 5A-5C, trapezoidal end windings 150C have a predominantly trapezoidal, as opposed to rectangular, cross-section. Trapezoidal end windings 150C include a bundle of conductive strands 138 that electrically connect to the strands 138 of two phase coils 142 (one on either end of each trapezoidal end winding 150C), coated in an insulative material 140, such as phase coils 142 shown in FIG. 3. In the embodiment shown in FIG. 6A, trapezoidal end winding 150C twists a total of 180°.

FIG. 6B is a perspective view including a plurality of non-linear end windings 150C. Slots 136 each include two phase coils 142, comprised of a plurality of conductive strands 138. Each non-linear end winding 150C electrically connects one phase coil 142 to another phase coil 142 positioned in a different slot 136. Trapezoidal end windings 150C follow the same routes as rectangular end windings 150B of FIGS. 5B-5C, but have a predominantly trapezoidal rather than rectangular cross-section when cut perpendicular to that route. The space between end winding 150B may be empty space, as depicted in the embodiment in FIG. 6B, or filled with insulative material.

FIG. 6C is a cross-sectional view of the plurality of trapezoidal end windings 150C shown in FIG. 6B, viewed from line 6C-6C. Adjacent pairs of trapezoidal end windings 150C are separated from one another by a predetermined minimum distance MD. Trapezoidal end windings 150C pack extremely densely with one another, which causes high packing density and fill factor, while maintaining electrical insulation between adjacent windings. Due to the positioning of the conductive material, the distance between pairs of adjacent trapezoidal end windings 150C is constant, and may be as small as predetermined minimum distance MD. Thus, high fill factors are achievable. The embodiment shown in FIGS. 6A-6C has a conductive fill factor that exceeds the fill factors achievable with linear leg end windings 150A or non-linear end windings 150B, as shown in FIGS. 4A and 5A, respectively.

By additively manufacturing non-linear end windings 150C, high densities of conductive material can be packaged into a relatively short end winding. In the embodiment shown in FIGS. 6A-6C, the ratio of linear leg end winding height H_{C} to laminated stack height H (FIG. 2) can be 1:6 or higher. In some embodiments, the ratio of linear leg end winding height H_{C} to laminated stack height H may be 1:9 or higher, or even 1:12 or higher. Height H_{C} can be smaller than height H_{B} for an otherwise equivalent motor design due to the higher density of end windings that may be accomplished with non-linear end windings 150C as compared to non-linear end windings 150B (FIGS. 5A-5C).

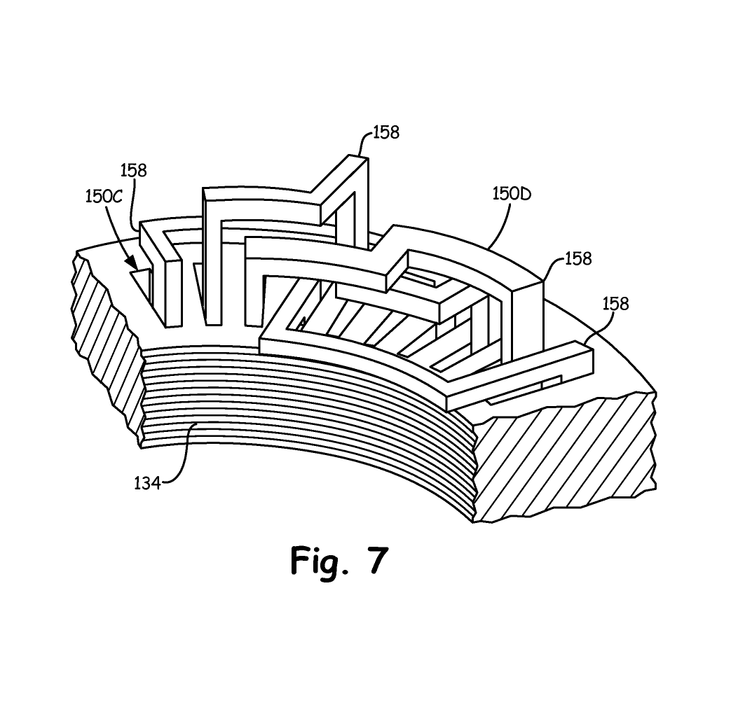

Another family of additively manufactured end windings is that of “stair-stepped” windings. FIG. 7 is a perspective view of one stair-stepped embodiment of end winding. The embodiments shown in FIGS. 4A-6C include end windings with smooth contours connecting the phases of electric machine 100. In contrast, the embodiment shown in FIG. 7 utilizes straight, stair-step style routing. Stair-stepped end windings 150D comprise a bundle of strands interconnecting like phases 142 (FIGS. 3-6) of laminated stack 134. Stair-stepped end windings 150D may incorporate a variety of structures, such as corners 158, to facilitate bypassing obstacles such as other stair-stepped end windings 150D.

Deposition of conductive material using additive manufacturing allows the conductor to be manufactured with corners, rather than the arcuate bends of traditional wire. Corners may be constructed in the end windings of embodiments of the present invention, and may be made at any angle. An appropriate angle for such corners may be chosen in order to maximize the fill factor and/or minimize length of the end windings being routed. Corners are constructed to allow for bypass jogs, thereby eliminating what would otherwise be an intersection between various end windings. At close approach, one or both of two end windings may jog out from its original path, then transition back to its original path and continue in the original direction once it has cleared the other winding. The jog to the second layer prevents an intersection with a short path diversion.

In one embodiment, layer-by-layer deposition of both the conductor paths and the material through which they travel (e.g., a glass or other insulating material) may occur nearly simultaneously. Conductors can be precisely placed such that they approach one another no closer than a predefined minimum distance allowed by the dielectric properties of the surrounding material. The pathways can have precise features not available using traditional wiring, such as 90° corners and small feature size which eliminate excess conductor length through precise path planning.

Per the present invention, electric machines utilize smooth end winding geometries (e.g. twisted quadrilateral, trapezoidal) and stair-stepped end winding configurations (e.g. sharp corners) to reduce the size and improve performance of the electric machine. For example, additive manufacturing permits the construction of windings having sharp corners, as well as a layered routings as in the stair-stepped approach. Each of these permit more dense packing than is otherwise possible. In the body of the stator, this high conductor packing factor makes it possible to significantly increase the electric loading of the machine, a key design metric for machine designers who are seeking to increase the machine shear stress (i.e., force per unit area of the rotor surface). The higher shear stress that is achievable with an optimized induction machine achieves superior weight and volume characteristics. Additively manufactured end windings can be configured to enable packing of the strands associated with different phases. End windings can be placed with very efficient path lengths in a very small volume extending a short distance from the electric machine.

For laying out circuit pathways in electronics, since the introduction of maze-router, line-search, and other algorithms, computational efficiency and tractable problem complexity have been improved. Non-orthogonal routing, multiple layers, and other features in electronics are now optimizable. End winding layouts may be arranged and additively manufactured along optimized routes that are planned by any of these efficient planning and/or optimization schemes for conductor routes. In some embodiments, these routes could be calculated using an optimization scheme to ensure that all paths have the same length or minimum combined length or meet other targets associated with motor design.

The ability to additively manufacture motor end windings, combined with optimized path planning, enables physical point-to-point pathway routing that is robust, fast, and produces systematically placed conductors with short and optimum pathway length. This method of end winding construction is well-suited to produce short, efficient, and precise conductor path lengths between many terminal pairs distributed among many coils of electric machine winding. Electrical losses in the end windings may be reduced by coupling additively manufactured end windings with an effective method of planning all conductor routes. This also enables reducing the distance from the motor occupied by the end windings, which can reduce the overall length of the motor. The path-planning approach is well suited to the stair-stepped family of end windings.

### Discussion of Possible Embodiments

The following are non-exclusive descriptions of possible embodiments of the present invention.

An electric machine includes a laminated stack including first and second additively manufactured conductive phase coils. Each of the first and second additively manufactured phase coils includes a plurality of conductive strands. An additively manufactured end winding conductively couples the first and second phase coils. The end winding has a non-circular cross-sectional geometry.

The electric machine of the preceding paragraph can optionally include, additionally and/or alternatively, any one or more of the following features, configurations and/or additional components:

The non-circular cross-sectional geometry may be quadrilateral or rectangular. The end winding may twist 180° between the first and second phase coils. The additively manufactured end winding may have a stair-stepped geometry. The end winding may include first and second linear legs extending from the first and second phase coils, respectively. A semicircular bridge may be arranged perpendicular to the laminated stack to connect to both the first and second linear legs, and the first and second linear legs and the semicircular bridge may each include a plurality of conductive portions embedded in an insulating material. The electrical machine may also include a plurality of slots each containing two phase coils. The two phase coils in each slot may be separated from one another by a predetermined minimum distance. The laminated stack has a first height, and the end windings have a second height, and the ratio of the first height to the second height may be greater than 6 to 1.

According to another embodiment, an end winding structure for an electric machine includes a plurality of conductive phase coils additively manufactured within a laminated stack. The end winding includes a plurality of conductive portions configured to selectively interconnect a plurality of strands of the phase coils. The end winding also includes an insulator material surrounding each of the plurality of conductive portions, wherein a fill factor of the strands comprising the phase coils is greater than 50%.

The end winding structure of the preceding paragraph can optionally include, additionally and/or alternatively, any one or more of the following features, configurations and/or additional components:

The end winding may be arranged along an optimized path. The plurality of conductive portions may be arranged in a region that has a non-circular cross-section. The region may have a quadrilateral cross-section. The laminated stack has a first height, and the plurality of conductive portions have a second height, and the ratio of the first height to the second height may be greater than 6 to 1. The plurality of phase coils may be connected by a plurality of end windings in an FSCW pattern. The end winding may include a 180° twist. The conductive end winding may also include first and second linear legs extending from the first and second phase coils, respectively, and a semicircular portion arranged perpendicular to the laminated stack, wherein the semicircular portion is connected to both the first and second linear legs. The linear legs may extend from the laminated stack at an angle 8 that is between 0° and 90°. At least two end windings may be separated from one another by at least a predetermined minimum distance. The distance between any two adjacent end windings may be constant.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An electric machine comprising:
a laminated stack including first and second additively manufactured conductive phase coils, each of the first and second additively manufactured phase coils comprised of a plurality of conductive strands; and
an additively manufactured end winding that conductively couples the first and second phase coils, wherein the end winding has a non-circular cross-sectional geometry.

2. The electric machine of claim 1, wherein the non-circular cross-sectional geometry is quadrilateral.

3. The electric machine of claim 2, wherein the non-circular cross-sectional geometry is rectangular.

4. The electric machine of claim 2, wherein the end winding twists 180° between the first and second phase coils.

5. The electric machine of claim 1, wherein the additively manufactured end winding has a stair-stepped geometry.

6. The electric machine of claim 2, wherein the end winding further comprises:
first and second linear legs extending from the first and second phase coils, respectively; and
a semicircular bridge arranged perpendicular to the laminated stack, wherein the semicircular bridge is connected to both the first and second linear legs;
wherein the first and second linear legs and the semicircular bridge each comprise a plurality of conductive portions embedded in an insulating material.

7. The electrical machine of claim 1, and further comprising a plurality of slots each containing two phase coils.

8. The electrical machine of claim 7, wherein the two phase coils in each slot are separated from one another by a predetermined minimum distance.

9. The electrical machine of claim 1, wherein the laminated stack has a first height, and the end windings have a second height, and the ratio of the first height to the second height is greater than 6 to 1.

10. An end winding structure for an electric machine having a plurality of conductive phase coils additively manufactured within a laminated stack, the end winding comprising:
a plurality of conductive portions configured to selectively interconnect a plurality of strands of the phase coils;
an insulator material surrounding each of the plurality of conductive portions, wherein a fill factor of the strands comprising the phase coils is greater than 50%.

11. The end winding structure of claim 10, wherein the end winding is arranged along an optimized path.

12. The end winding structure of claim 10, wherein the plurality of conductive portions are arranged in a region that has a non-circular cross-section.

13. The end winding structure of claim 12, wherein the region has a quadrilateral cross-section.

14. The end winding structure of claim 10, wherein the laminated stack has a first height, and the plurality of conductive portions have a second height, and the ratio of the first height to the second height is greater than 6 to 1.

15. The end winding structure of claim 10, wherein the plurality of phase coils are connected by a plurality of end windings in an FSCW pattern.

16. The end winding structure of claim 10, wherein the end winding includes a 180° twist.

17. The end winding structure of claim 10, wherein the conductive end winding further comprises:
first and second linear legs extending from the first and second phase coils, respectively; and
a semicircular portion arranged perpendicular to the laminated stack, wherein the semicircular portion is connected to both the first and second linear legs.

18. The end winding structure of claim 17, wherein each of the linear legs extend from the laminated stack at an angle 8 that is between 0° and 90°.

19. The end winding structure of claim 10, wherein at least two end windings are separated from one another by at least a predetermined minimum distance.

20. The end winding structure of claim 19, wherein the distance between any two adjacent end windings is constant.
